(19) United States
(12) Patent Application Publication
(10) Pub. No.: US 2013/0239113 A1
(43) Pub. Date: Sep. 12, 2013

(54) INFORMATION PROCESSING APPARATUS, COMPUTER PRODUCT, AND INFORMATION PROCESSING METHOD

(71) Applicant: FUJITSU LIMITED, Kawasaki-shi (JP)

(72) Inventors: Koji KURIHARA, Kawasaki (JP); Koichiro Yamashita, Hachioji (JP); Hiromasa Yamauchi, Kawasaki (JP); Takashisa Suzuki, Kawasaki (JP)

(73) Assignee: FUJITSU LIMITED, Kawasaki-shi (JP)

(21) Appl. No.: 13/856,775

(22) Filed: Apr. 4, 2013

Related U.S. Application Data
(63) Continuation of application No. PCT/JP2010/067467, filed on Oct. 5, 2010.

(51) Int. Cl. G06F 9/46

(52) U.S. Cl. CPC G06F 9/46
USPC 718/103

(57) ABSTRACT

An information processing apparatus includes a memory unit having numbers each specifying an output order and a data memory area corresponding to each number; a setting unit that sets in each data memory area correlating an execution order of a thread with a number specifying the output order, a storage location for a value of a common variable of the thread among threads receiving write requests for the value or the common variable; a first storing unit that stores to the data memory area set for each thread, the value of the common variable for the thread of the execution order corresponding to the number specifying the output order of the data memory area; and a second storing unit that upon completion of ail the threads and In the output order, reads-out each value of the common variable stored to the data memory areas and overwrites a specific storage location.

### CROSS REFERENCE TO RELATED APPLICATIONS

This application is a continuation application of International Application PCT/JP2010/06746, filed on Oct. 5, 2010 and designating the U.S., the entire contents of which are incorporated herein by reference.

### FIELD

The embodiment discussed herein is related to an information processing apparatus, program, and method.

### BACKGROUND

In a multi-thread process, one process is divided into multiple threads and the threads are executed concurrently. In this process, a certain variable is overwritten by the threads. A variable overwritten by the threads is referred to as a common variable.

In a single-core processor system, threads having a common variable are executed through serial processing, thereby preventing a case where the final value of the common variable varies consequent a change in the execution order of the threads.

A banner display process by a browser will be described with regard to a conation variable. In the banner display process, data to be displayed is stored in a shared memory. When multiple banner display processes are executed, data to be displayed by each banner display process is stored in the memory according to the display order of the banners (Z order) described in a hyper text makeup language (HTML) document. Displayed banners may overlap each other depending on display patterns. To avoid such a case, the banner display process must be executed according to the display order of the banners. Hence, the serial process is performed as described above.

In a shared memory multi-core processor system, a multi-core processor assigns each thread to an arbitrary central processing unit (CPU), where the thread is processed. In the multi-core processor system, each CPU executes a thread assigned thereto regardless of the execution status of other CPUs. When executing a thread having a common variable, each CPU must perform serial processing or concurrent processing of the thread and other threads having the common variable (see, for example, Mase, M. et al, “Automatic Parallelization of Parallelizable C Programs on Multicore Processors”, 2009 Information Processing Society of Japan).

However, serial processing has a problem of reduced throughput and the concurrent processing has a problem of reduced performance due to overhead.

### SUMMARY

According to an aspect of an embodiment, an information processing apparatus includes a memory unit having a number group specifying an output order to an output destination and a data memory area corresponding to each number of the number group; a setting unit that sets in each data memory area correlating an execution order of a thread with a number specifying the output order, a storage location for a value of a common variable of the thread among a group of threads receiving a write request for the value of the common variable in a given process; a first storing unit that stores to the data memory area set for each thread of the thread group, the value of the common variable for the thread of the execution order corresponding to the number specifying the output order of the data memory area; and a second storing unit that upon completion of all threads of the thread group, reads out in the output order, each value of the common variable stored by the first storing unit to the data memory area for each thread, and that in the output order, overwrites a specific storage location with each read-out value of the common variable.

The object and advantages of the invention will be realised and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one embodiment of the present invention;

FIG. 2 is a block diagram of hardware of an information processing apparatus;

FIG. 3 is an explanatory diagram of one example of a thread management table 300;

FIG. 4 is an explanatory diagram of one example of execution order data;

FIG. 5 is an explanatory diagram of one example of common variable data;

FIG. 6 is a block diagram of an information processing apparatus 200;

FIG. 7 is an explanatory diagram of a starting example of process 1;

FIG. 8 is an explanatory diagram of an allocation example of each thread of a given process;

FIG. 9 is an explanatory diagram of detection example 1 of a write request from thread 1;

FIG. 10 is an explanatory diagram of detection example 2 of a write request from thread 1;

FIG. 11 is an explanatory diagram of a detection example of a write request from thread 3;

FIG. 12 is an explanatory diagram of detection example 1 of a write request from thread 2;

FIG. 13 is an explanatory diagram Of detection example 2 of a write request from thread 2;

FIG. 14 is an explanatory diagram of a detection example of a write request from thread 4;

FIG. 15 is an explanatory diagram of an example of detection of the completion of thread 4;

FIG. 16 is an explanatory diagram of an example of detection of the completion of all threads;

FIG. 17 is a flowchart of an information processing procedure by the OS 210;

FIG. 18 is a flowchart of an information processing procedure by each OS;

FIG. 19 is a flowchart of a control procedure by the OS 210 at the time of completion of a thread that writes to the common variable; and

FIG. 20 is a flowchart of an output procedure by an OSD processing unit 203.

### DESCRIPTION OF EMBODIMENTS

Preferred embodiments of the present invention will be explained with reference to the accompanying drawings.

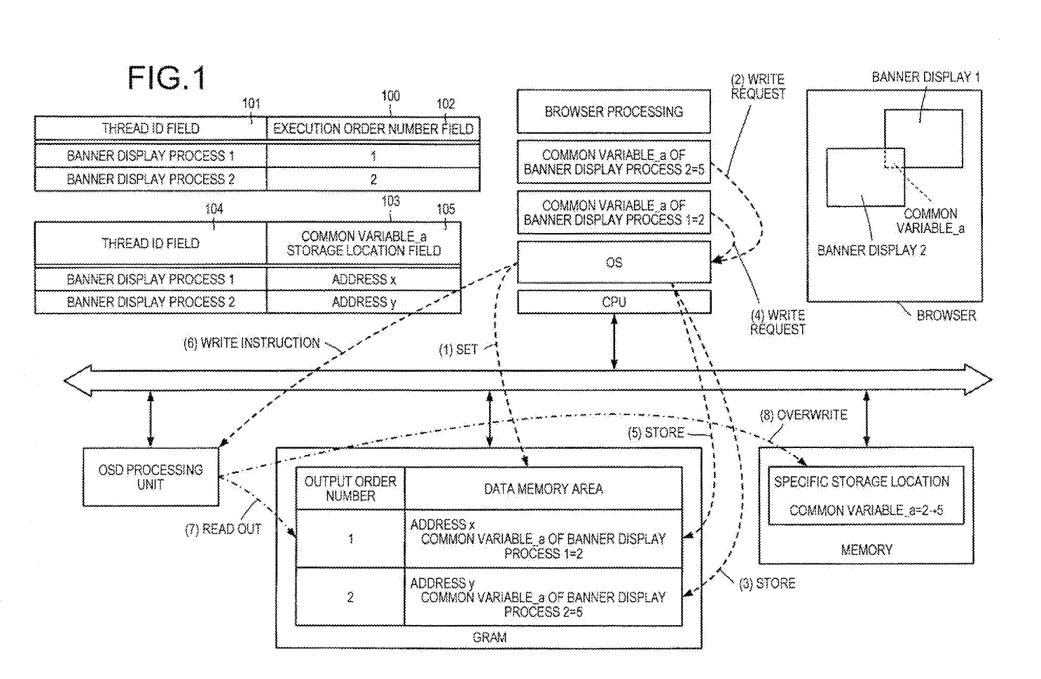

FIG. 1 is an explanatory diagram of one embodiment of the present invention. Banner display 1 and banker display 2 within a browser are given as one example of an application. In FIG. 1, overlapping parts of the banner displays in the browser are given as a common variable_a. A table 100 includes information indicating the execution order of threads in browser processing. The table 100 has a thread ID field 101 and an execution order number field 102. In the thread ID field 101, identification information of the thread is registered. In the execution order number field 102, the number indicating the execution order is registered. The execution order number is information obtained by HTML document analysis in the browser processing.

A table 103 includes information indicating a storage location ox the value of the common variable_a for each thread haying the common variable_a. The table 103 has a thread ID field 104 and a common variable_a storage location field 105. In the thread ID field 104, identification information of the thread is registered. In the common variable_a storage location field 105, the address of the storage location on a graphic random access Memory (GRAM) is registered by an OS.

The GRAM has a number group specifying the output order to an output destination and a data memory area corresponding to each number of the number group. The output destination is a display device. An OSD processing unit outputs to the output destination and in the output order, the data stored in the data memory area of the GRAM.

When the browser processing starts, the OS (1) sets in a data memory area correlating the execution order of each thread and the number specifying the output order within the GRAM (output order number), the storage location of the value of the common variable_a that is common to a banner display process 1 and a banner display process 2 included in the browser processing. The output order number within the GRAM is set based on the table 100. The OS sets each storage location indicated in the table 103.

The OS (2) upon detecting a request to write the common variable_a from the banner display process 2, (3) stores the value of the common variable_a of the banner display process 2 to the data memory area set for the banner display process 2. The OS (4) upon detecting a request to write the common variable_a from the banner display process 1, (5) stores the value of the common variable_a of the banner display process 1 to the data memory area set for the banner display process 1.

The OS upon detecting completion of the banner display process 1 and the banner display process 2, (6) sends to the OSD processing unit, a write instruction. The OSD processing unit (7) reads out in the output order, each value of the common variable_a stored in the data memory areas, and (8) overwrites the value of the common variable_a at a specific storage location with the read-out values.

Consequently, even if writing of the value of the common variable_a in the banner display process 1 is executed after writing of the value of the common variable_a in the banner display process 2, the value of the common variable_a at the specific storage location becomes the value of the common variable_a in the banner display process 2.

In this embodiment, description will be made using a multi-core processor system as one example of the information processing apparatus. In the multi-core processor system, a multi-core processor is a processor having multiple cores. Multiple cores may be provided as a single processor having multiple cores or as a group of single core processors in parallel. In this embodiment, for a simplified description, description will be made using an example of a group of single core processors in parallel.

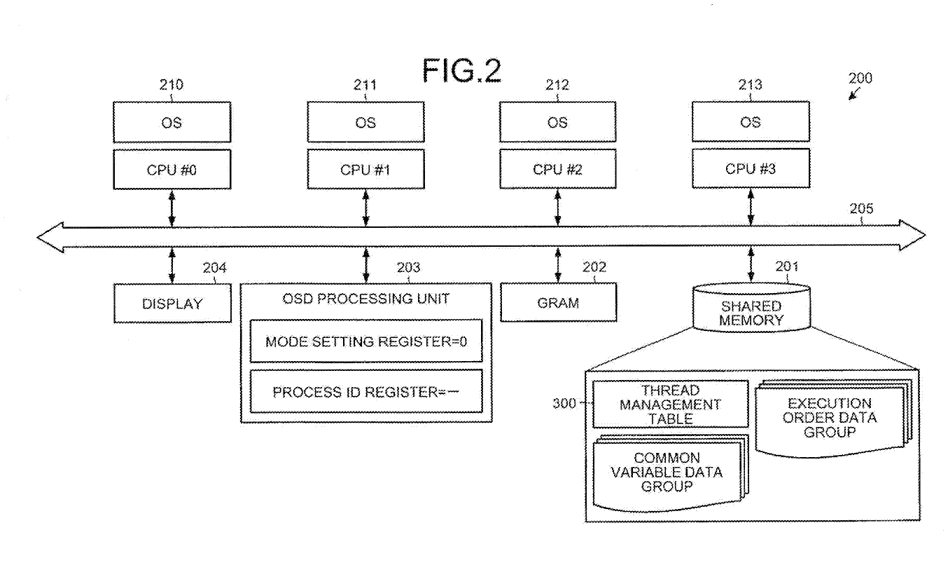

FIG. 2 is a block diagram of hardware of the information processing apparatus. An information processing apparatus 200 includes CPU#0 to CPU#3, shared memory 201, GRAM 202, an OSD processing unit 203, and a display 204, respectively connected by a bus 205.

The CPU#0 to the CPU#3 respectively has a core, a register, and a cache. The CPU#0 executes an OS 210 and governs overall control of the information processing apparatus 200. The OS 210 is a master OS, has a function of controlling thread allocation to the CPUs, and executes threads allocated to the CPU#0.

CPU#1, the CPU#2, and the CPU#3 execute an OS 211, an OS 212, and OS 213, respectively and execute the threads allocated to the OSs, respectively. The OS 211 to the OS 213 are slave OSs.

The GRAM 202, in the same manner as depicted in FIG. 1, has a number group specifying the output order to an output destination and data memory areas respectively corresponding to each number of the number group. The output destination is the display 204.

display 204, in addition to cursors, icons, and tool boxes, displays data such as documents, images, and functional information. For example, a TFT liquid crystal display, a plasma display, etc. can be employed as the display 204.

The OSD processing unit 203 has the function of outputting the data stored in the GRAM 202 to the display 204 or the shared memory 201 based on Z value. The OSD processing unit 203 has a mode setting register and a process ID register. The mode setting register is a register indicating whether the data is output to the display 204 or to the shared memory 201. The mode setting register is a 1-bit register.

When the value of the mode setting register is 0, the output destination of the data by the OSD processing unit 203 is the display 204 and when the value of the mode setting register is 1, the output destination of the data by the OSD processing unit 203 is the shared memory 201. This embodiment assumes detection, by the OSD processing unit 203, of a change in the value of the mode setting register from 0 to 1 to be a detection of an instruction to write to the shared memory 201.

The process ID register is a register in which identification information of the process is registered. The OSD processing unit 203, upon detecting an instruction to write to the shared memory 201, outputs to the shared memory 201 and in the order of the Z value, data chat is in the GRAM 202 and corresponds to the identification information of the process registered in the process ID register.

The shared memory 201, for example, has read only memory (ROM), random access memory (RAM), flash ROM, etc, For example, the flash ROM stores a boot program, the ROM stores application software, and the RAM is used as a work area of the CPU#0 to the CPU#3. Programs stored in the shared memory 201 and loaded on the CPUs, cause the CPUs to execute process. The shared memory 201 stores, for example, a thread management table 300, an execution order data group, and a common variable data group.

The thread management table 300 includes information for managing allocation destination CPUs of the threads, for each process for which an instruction to start is received.

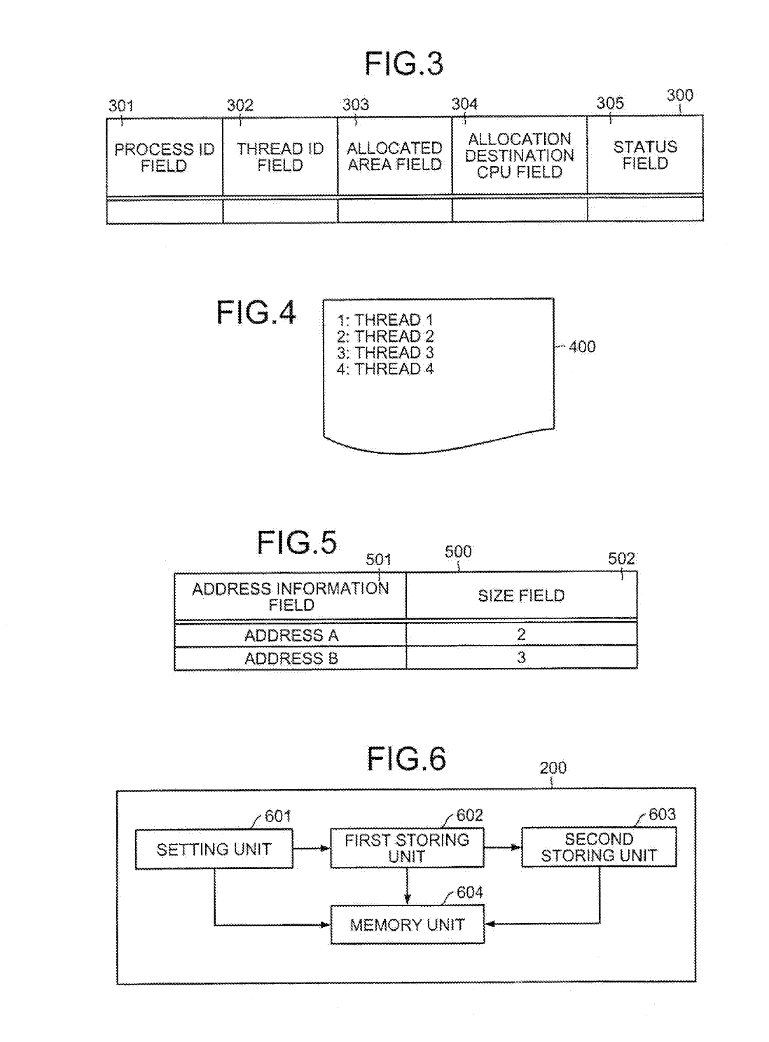

FIG. 3 is an explanatory diagram of one example of the thread management table 306. The thread management table 300 includes a process ID field 301, a thread ID field 302, an allocated area field 303, an allocation destination CPU field 304, and a status field 305.

The process ID field 301 holds a process ID. The thread ID field 302 holds a thread ID of a thread included in the process. The allocated area field 303 holds an address of a memory area established in the GRAM 202, for each thread. The allocation destination CPU field 304 holds identification information of the CPU to which the thread is allocated. The status field 305 holds a status of the thread. There are three statuses of the thread: “unallocated”, “under execution”, and “completed”.

For example, the OS 210, upon receipt of an instruction to start a process, registers into the process ID field 301 in the thread management table 300, the identification information of the process for which the instruction to start has been received. The OS 210 registers into the thread ID field 302 in the thread management table 300, the identification information of a thread included in the process and further registers “unallocated” in the status field 305.

In FIG. 2, each execution order data among the execution order data group is, for example, information indicating for each process, the execution order of the threads that include the common variable. In this embodiment, the execution order is given as one example of a specific order at the time of storing the common variable of each thread in the GRAM 202 in the shared memory 201.

FIG. 4 is an explanatory diagram of one example of the execution order data. Execution order data 400 is the information indicating the execution order of the threads that include the common variable, in process 1. It is assumed that, in process 1, thread 1 is executed first, thread 2 executed second, thread 3 executed third, and thread 4 executed fourth. It is assumed that the OS registers the number indicating the execution order as the Z value of the GRAM 202.

FIG. 5 is an explanatory diagram of one example of the common variable data. Common variable data 500 is information concerning the common variable in process 1. The common variable data 500 includes an address information field 501 and a size field 502. The address information field 501 holds the address information indicating an address in the shared memory 201 and the size field 502 holds the site of the variable to be stored at the address indicated by the address information in the address information field 501. The common variable of process 1 is a variable to be stored at address A of the shared memory 201 and at address B of the shared memory 201.

The size of the variable to be stored at address A of the shared memory 201 is 2 bytes and the size of the variable to be stored at address B of the shared memory 201 is 3 bytes. A 2-byte area for the variable that is to be stored at address A of the shared memory 201, an area of a size sufficient to store address A, a 3-byte area for the variable that is to be stored at address B of the shared memory 201, and an area of a size sufficient to store address B are set for each thread that includes the common variable.

FIG. 6 is a block diagram of the information processing apparatus 200. The information processing apparatus 200 has a setting unit 601, a first storing unit 602, a second storing unit 603, and a memory unit 604. The memory unit 604 is the GRAM 202. The setting unit 601 is implemented by executing on the CPU#0, the OS 210 having the information processing program stored in the shared memory 201. The first storing unit 602 is implemented by executing on each CPU, the OS having the information processing program shored in the shared memory 201. A function of the second storing unit 603 is implemented when the OS sends to the OSD processing unit 203, a write instruction and the OSD processing unit receives the write instruction.

The memory unit 604 has a number group specifying an output order to the output destination and data memory areas respectively corresponding to each number of the number group.

The setting unit 601 sets in the data memory area correlating the execution order of each thread and the number specifying the output order, the storage location of the value of the same common variable of each thread among a group of threads having a write request for the value of the common variable in a given process.

The first storing unit 602 stores to the data memory area set for each thread of the thread group by the setting unit 601, the value of the common variable of the thread of the execution order corresponding to the number specifying the output order of the data memory area.

When all threads of the thread group have finished, the second storing unit 603 reads out in the output order, each value of the common variable stored to a data memory area for each thread by the first storing unit 602 and in the output order, overwrites the specific storage location with each read-out value of the common variable.

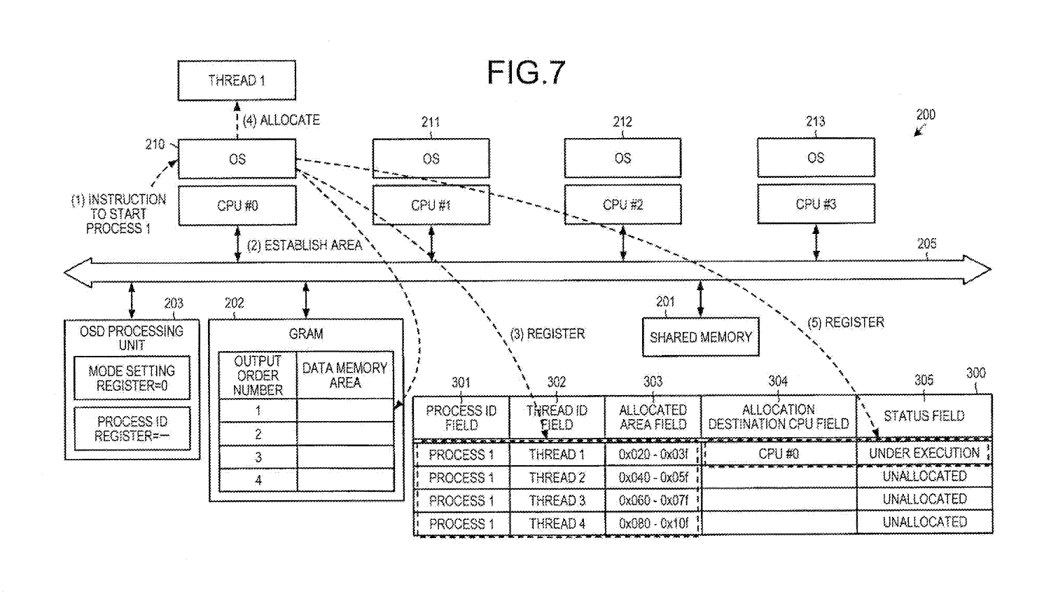

FIG. 7 is an explanatory diagram of a starting example of process 1. The OS 210 (1) upon detecting an instruction to start process 1, (2) sets a memory area to store the common variable in the GRAM 202, for each thread handling the conation variable among the threads of process 1, based on the common variable data 500. In this embodiment, it is assumed that in the respective area set (for each thread) in the shared memory 201, storage locations of the variable to be stored at address A of the shared memory 201 that stores a memory area set for each thread, the variable to be stored at address B of the shared memory 201, address A, and address B have been determined.

The OS 210 (3) registers information concerning process 1 in the thread management table 300. The OS 210 (4) allocates thread 1 to the CPU#0 and (5) registers the allocation destination CPU of thread 1 into the thread management table 300.

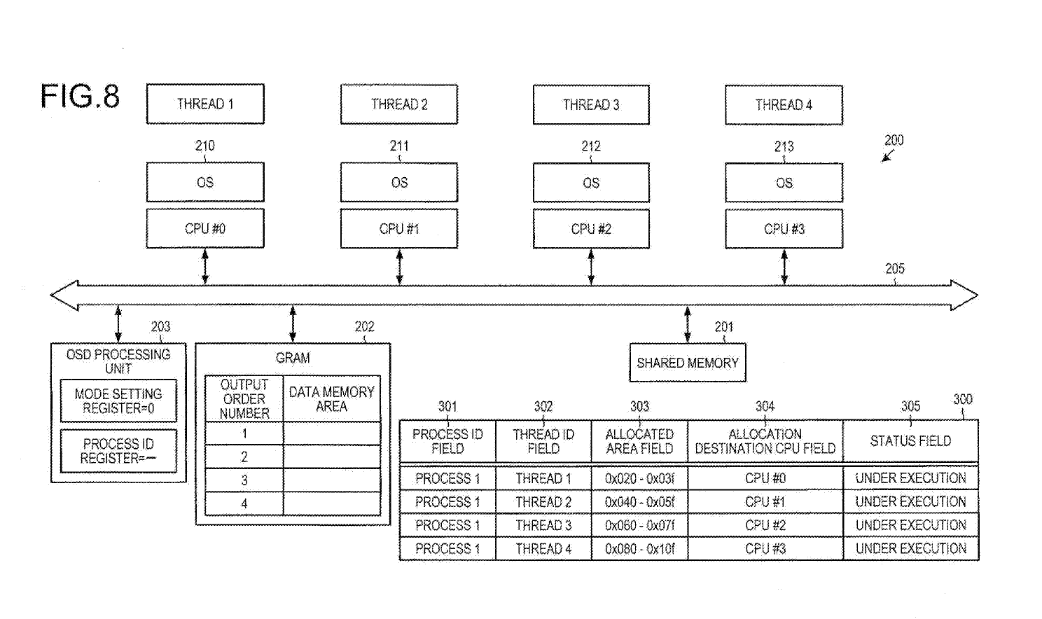

FIG. 8 is an explanatory diagram of an allocation example of each thread of a given process. In FIG. 8, thread 1 is allocated to the CPU#2, thread 2 to the CPU#1, thread 3 to the CPU#2, and thread 4 to the CPU#3. The allocation destination CPU of each thread is registered into the thread management table 300.

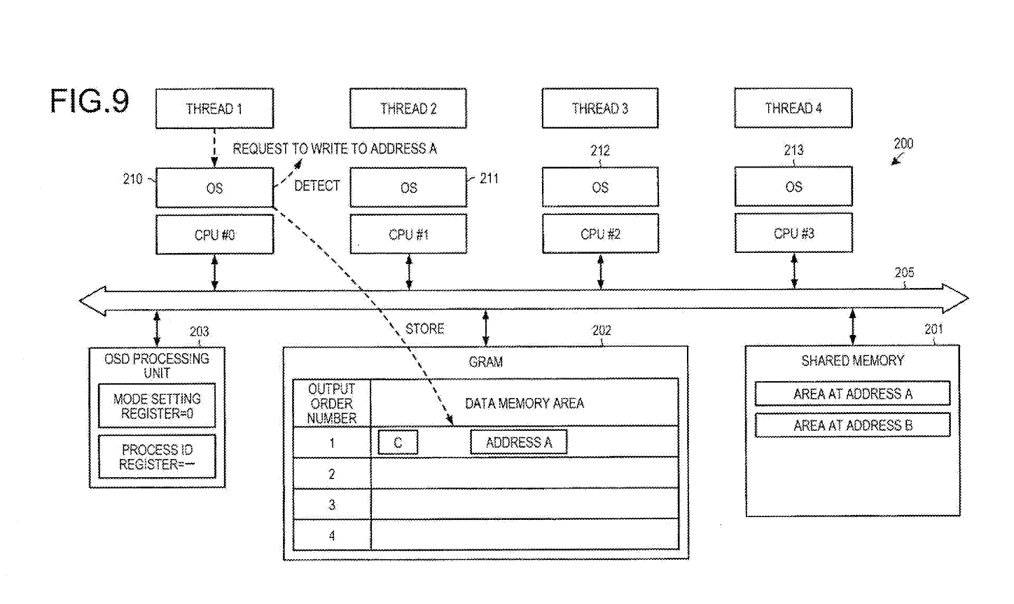

FIG. 9 is an explanatory diagram of detection example 1 of a write request from thread 1. The OS 210, upon detecting a write request from thread 1, retrieves from the common variable data 500, address A as a writing destination address of the write request. Upon retrieving address A from the common variable data 500, one OS 210 acquires the address of the memory area of thread 1 in the GRAM 202 from the thread management table 300. Based on the acquired address, the OS 210 executes the request to write to the GRAM 202. Data C and address A are stored to the memory area of thread 1, in the GRAM 202.

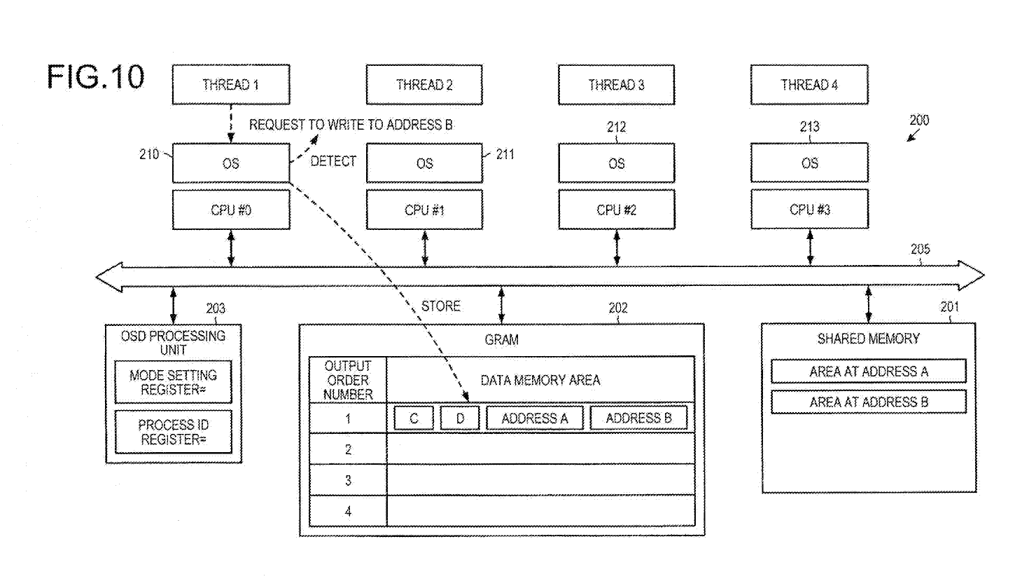

FIG. 10 is an explanatory diagram of detection example 2 of a write request from thread 1. The OS 210, upon detecting, a write request from thread 1, retrieves from the common variable data 500, address B as a writing destination address of the write request. Upon retrieving address B from the common variable data 500, the OS 210 acquires the address of the memory area of thread 1 in the GRAM 202 from the thread management table 300. Based on the acquired address, the OS 210 stores data D and address B to the memory are of thread 1. Data C, data D, address A, and address a are stored to the memory area of thread 1, in the GRAM 202.

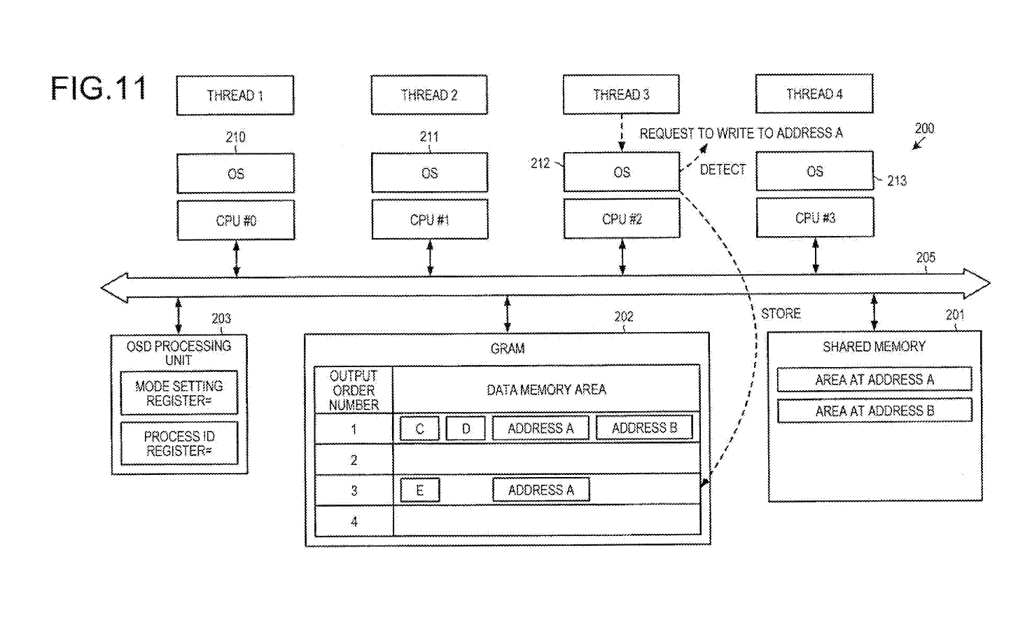

FIG. 11 is an explanatory diagram of a detection example of a write request from thread 3. The OS 212, upon detecting a write request from thread 3, retrieves from the common variable data 500, address A as the writing destination address of the write request. Upon retrieving address B from the common variable data 500, the OS 212 acquires the address of the memory area of thread 3 in the GRAM 202 from the thread management table 300. Based on the acquired address the OS 212 stores data E and address A to the memory area of thread 3. Data E and address A are stored to the memory area of thread 3, in the GRAM 202.

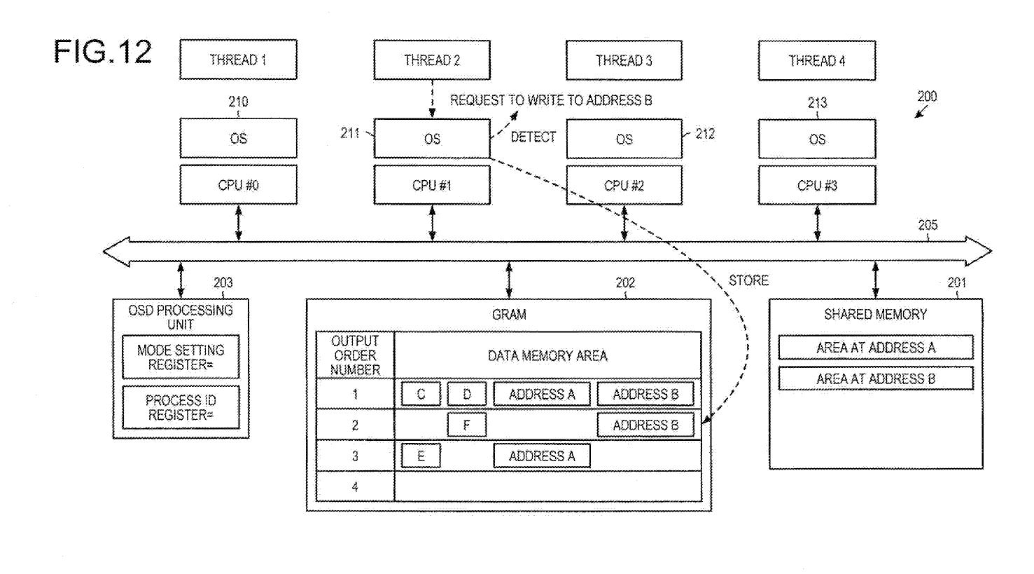

FIG. 12 is an explanatory diagram of detection example 1 of a write request from thread 2. The OS 211, upon detecting a write request from thread 2, retrieves from the common variable data 500, address B as the writing destination address of the write request. Upon retrieving address B from the common variable data 500, the OS 211 acquires the address of the memory area of thread 2 in the GRAM 202 from the thread management table 300. Based on the acquired address, the OS 211 stores data F and address B to the memory area of thread 2. Data F and address B are stored to the memory area of thread 2, in the GRAM 202.

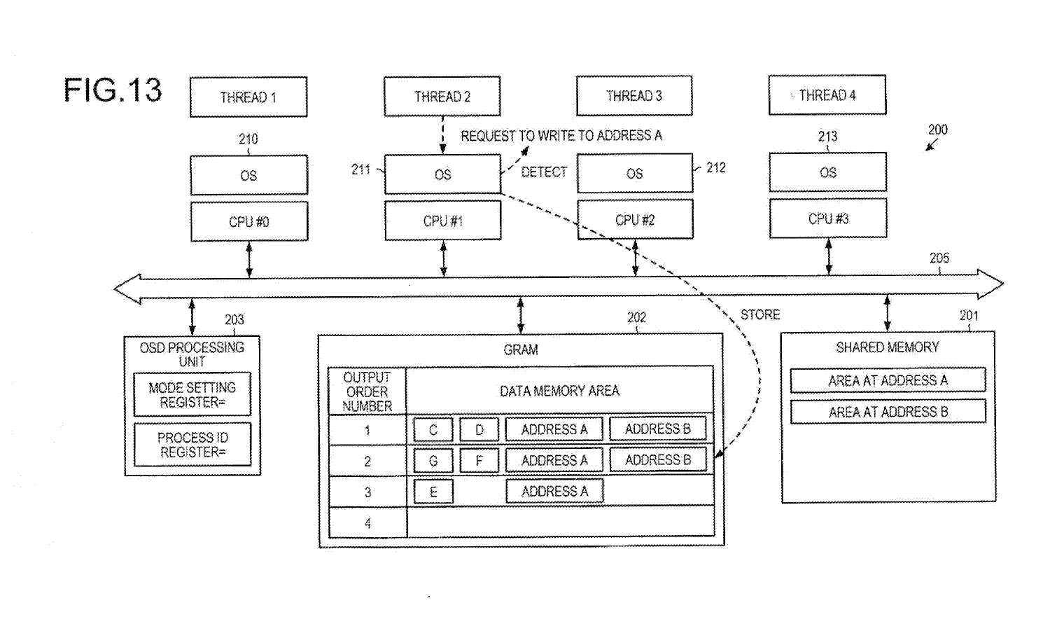

FIG. 13 is an explanatory diagram of detection example 2 of a write request from thread 2. The OS 211, upon detecting a write request from thread 2, retrieves from the common variable data 500, address A as the writing destination address of the write request. Upon retrieving address A from the common variable data 500, the OS 211 acquires the address of the memory area of thread 2 in the GRAM 202 from the thread management table 300. Eased on the acquired address, the OS 211 stores data G and address A to the memory area of thread 2, in the GRAM 202. Data G and address A are stored to the memory area of thread 2, in the GRAM 202.

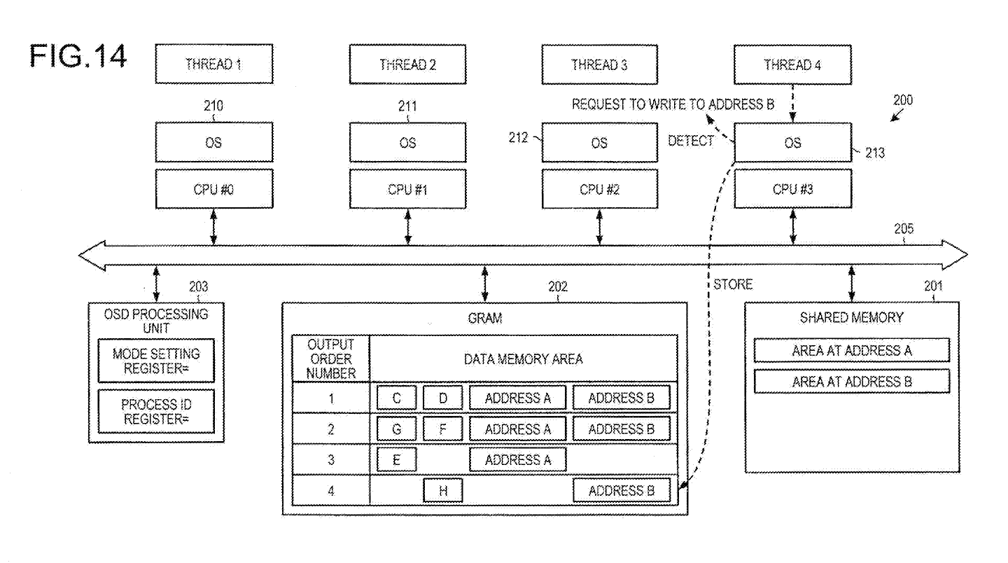

FIG. 14 is an explanatory diagram of a detection example of a write request from thread 4. The OS 213, upon detecting a write request from thread 4, retrieves from the common variable data 500, address B as the writing destination address of the write request. Upon retrieving address B from the common variable data 500, the OS 213 acquires the address of the memory area of thread 4 in the GRAM 202 from the thread management table 300. Based on the acquired address, the OS 213 stores data H and address B to the memory area of thread 4. Data H and address B are stored to the memory area of thread 4, in the GRAM 202.

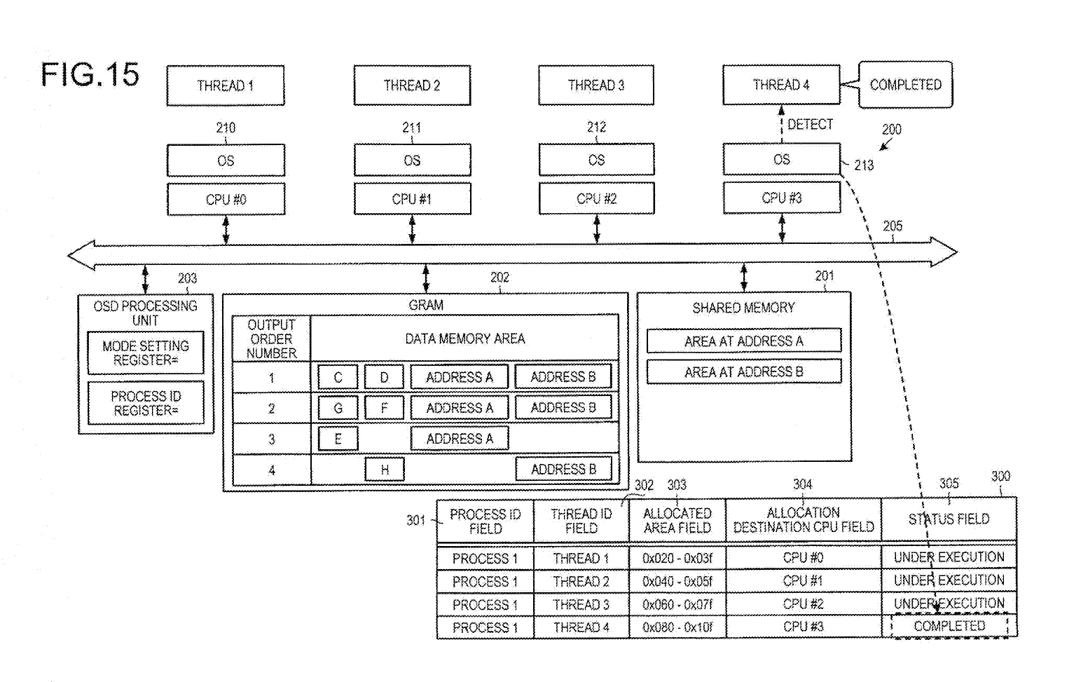

FIG. 15 is an explanatory diagram of an example of detection of the completion of thread 4. The OS 213, upon detecting a completion of thread 4, updates in the thread management table 300, the status field 305 of thread 4 with respect to process 1, from “under execution” to “completed”.

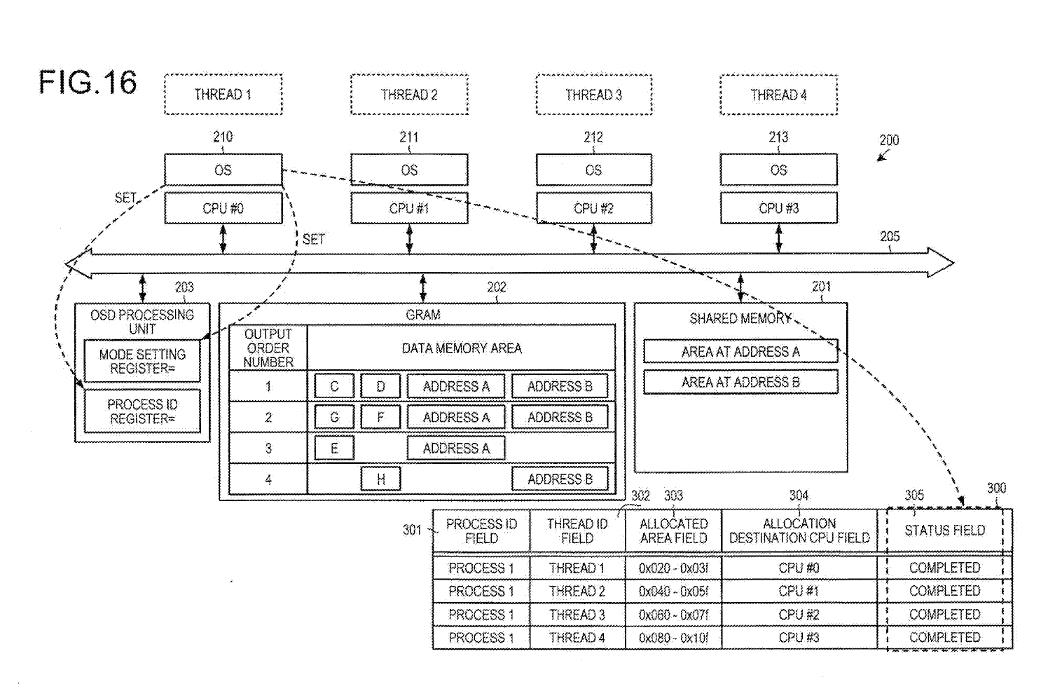

FIG. 16 is an explanatory diagram of an example of detection of the completion of all threads. Upon detecting a completion of all threads of process 1 based on the updating of the status field 305 of the thread management table 300, the OS 210 sets the process ID register of the OSD processing unit 203 to 1 and sets the mode setting register to 1.

Upon detecting a change of the mode setting register to 1, the OSD processing unit 203, based on the value set in the process ID register and by using the thread management table 300, identifies the memory areas in the GRAM 202 to be output from GRAM 202 to the shared memory 201. The OSD processing unit 203 stores the data to the shared memory 201 from the identified memory areas in the GRAM 202, according to ascending order of the Z value of the area.

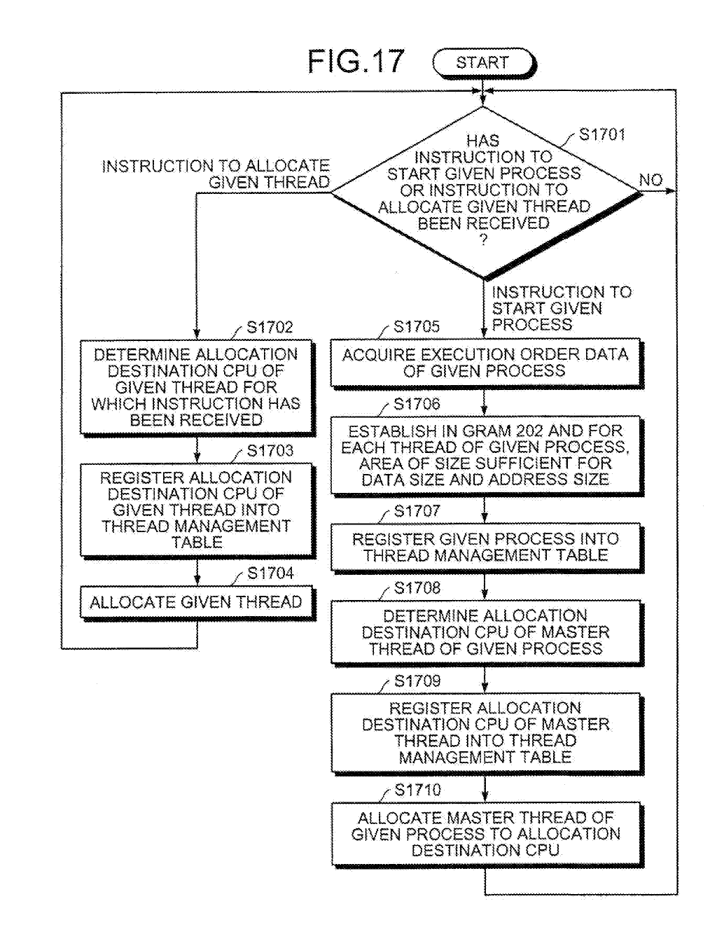

FIG. 17 is a flowchart of an information processing procedure by the OS 210. The OS 210 judges if an instruction to start a given process or an instruction to allocate a given thread has been received (step S1701). If the OS 210 judges that neither an instruction to start a given process nor an instruction to allocate a given thread has been received (step S1701; NO), the flow returns to step S1701.

At step S1701, if the OS 210 judges that an instruction to allocate a given thread has been received (step S1701: INSTRUCTION TO ALLOCATE GIVEN THREAD), the OS 210 determines an allocation destination CPU of the given thread for which the instruction to allocate has been received (step S1702). The OS 210 registers the allocation destination CPU of the given thread into the thread management table 300 (step S1703), allocates the given thread (step S1704), and returns to step S1701.

At step S1701, if the OS 210 judges that an instruction to start a given process has been received (step S1701: INSTRUCTION TO START GIVEN PROCESS), the OS 210 acquires the execution order data 400 of the given process (step S1705). The OS 210 establishes in the GRAM 202 and for each thread of the given process, an area of a size sufficient for the data size and the address size (step S1706).

The OS 210 registers the given process into the thread management table 300 (step S1707) and determines the allocation destination CPU of a master thread of the given process (step S1708). The OS 210 registers the allocation destination CPU of the master thread into the thread management table 300 (step S1709), allocates the master thread of the given process to the allocation destination CPU (step S1710), and returns to step S1701.

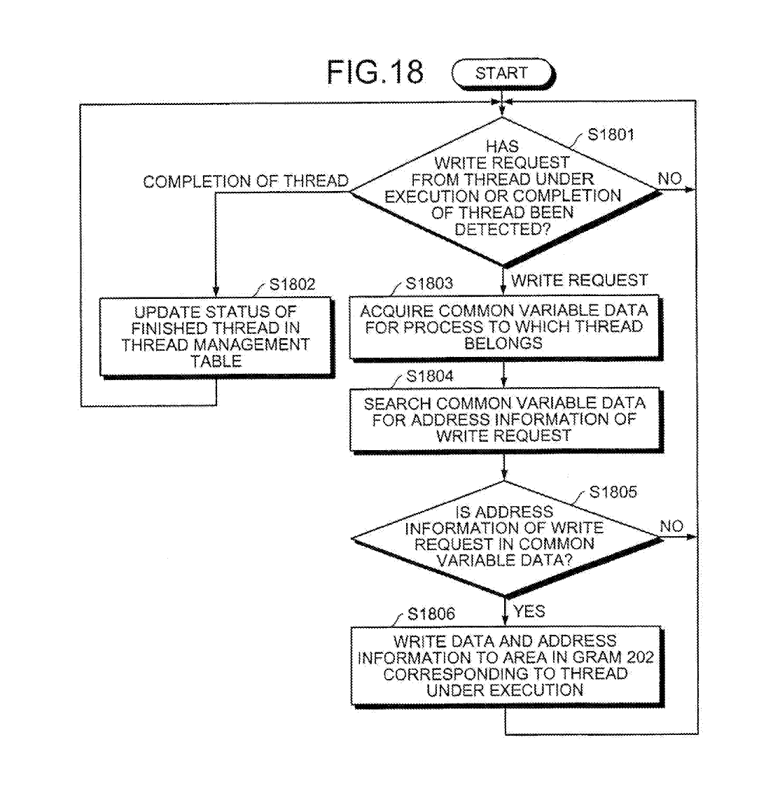

FIG. 18 is a flowchart of an information processing procedure by each OS. While the information processing procedure depicted in FIG. 18 is executed by each OS, description will be made using an example of the OS 210. The OS 210 judges if a write request from the thread under execution or the completion of the thread has been detected (step S1801). If the OS 210 judges that neither a write request from the thread under execution nor the completion of the thread has been detected (step S1801: NO), the flow returns to step S1801.

If the OS 210 judges that the completion of the thread under execution has been detected (step S1801: COMPLETION OF THREAD), the OS 210 updates the status of the finished thread in the thread management table 300 (step S1802) and returns to step S1801. If the OS 210 judges that a write request from the thread under execution has been detected (step S1801: WRITE REQUEST), the OS 210 acquires the common variable data for the process to which the thread belongs (step S1803).

The OS 210 searches the common variable data for address information of the write request (step S1804) and judges if the address information of the write request is in the common variable data (step S1805). If the OS 210 judges that the address information of the writs request is not in the common variable data (step S1805: NO), the flow returns to step S1801.

If the OS 210 judges that the address information of the write request is in the common variable data (step S1805: YES), the OS 210 writes the data and the address information to the area in the GRAM 202, corresponding to the thread under execution (step S1806) and returns to step S1801.

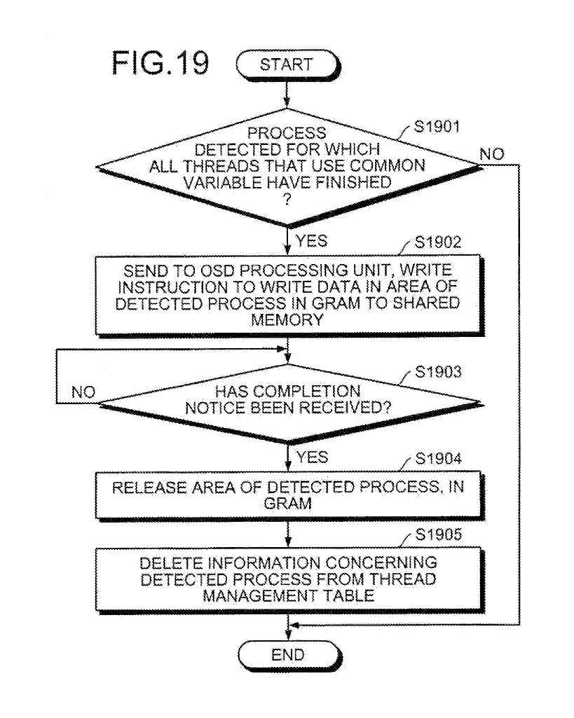

FIG. 19 is a flowchart of a control procedure by the OS 210 at the time ox completion of a thread that writes to the common variable. The OS 210 judges whether a process is detected fox which all threads that use the common variable have finished (step S1801). If the OS 210 judges that a process is not detected for which all threads that use the common variable are finished (step S1901: NO), the processing according to the flowchart is ended.

On the other hand, if the OS 210 judges that a process is detected for which all threads that use the common variable are finished (step S1901: YES), the OS 210 sands to the OSD processing unit 203, a write instruction to write the data in the area of the detected process in the GRAM 202 to the shared memory 201 (step S1902). The write instruction indicates the setting of a mode setting flag to 1.

The OS 210 judges if a completion notice from the OSD processing unit 203 has been received (step S1903). If the OS 210 judges that a completion notice from the OSD processing unit 203 has nor been received (step S1903: NO), the flow returns to step S1903. If the OS 210 judges that a completion notice from the OSD processing unit 203 has been received (step S1903; YES), the OS 210 releases the area of the detected process, in the GRAM 202 (step S1904). The OS 210 deletes information concerning the detected process from the thread, management table 300 (step S1905), ending the processing according ho the flowchart.

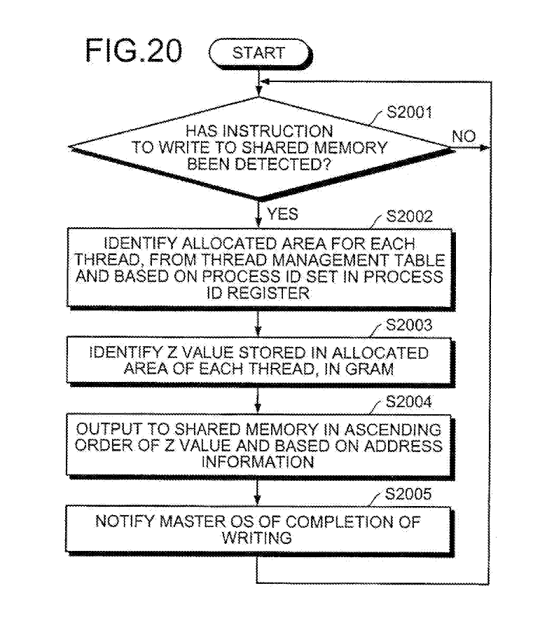

FIG. 20 is a flowchart of an output procedure by the OSD processing unit 203. The OSD processing unit 203 judges if an instruction to write to the shared memory has been detected (step S2001). A detection of a write instruction indicates a change of the mode setting flag from 0 to 1.

If the OSD processing unit 203 judges that an instruction to write to the shared memory has not been detected (step S2001: NO), the flow returns to step S2001. If the OSD processing unit 203 judges that an instruction to write to the shared memory has been detected (step S2001: YES), the OSD processing unit 203 identifies an allocated area for each thread, from the thread management table 300 and based on the process ID set in the process ID register (step S2002).

The OSD processing unit 203 identifies the Z value stored in the allocated area of each thread, in the GRAM 202 (step S2003), outputs data from the GRAM 202 to the shared memory in ascending order of the Z value (step S2004), notifies the master OS of the completion of writing (step S2005) and returns to step S2001. The OSD processing unit 203 notifies the master OS of the completion of writing as well as a setting of the mode setting register to 0.

As described, according to the information processing apparatus, the information processing program, and the information processing method, the value of the common variable of each thread of the group of threads having the common variable and in the given process, is stored in an area of the GRAM in which the execution order of each thread corresponds to the number specifying the output order. After completion of all threads of the thread group, the value of the common variable is read out from the GRAM in the order of the number specifying one output order and is written to the specific storage location in the order of the number specifying the output. Even if the execution order of the thread group at the time of operation is different from the execution order of the thread group defined by the process, the ultimate value of the common variable can be prevented from differing and the throughput and performance can be enhanced.

Functions can be realised easily by handling the value of the common variable of each thread in a separate area and using the existing hardware of the GRAM.

The information processing apparatus, the information processing program, and the information processing method enable throughput and performance to be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory unit having a number group specifying an output order to an output destination and a data memory area corresponding to each number of the number group;
a setting unit that sets in each data memory area correlating an execution order of a thread with a number specifying the output order, a storage location for a value of a common variable of the thread among a group of threads receiving a write request for the value of the common variable in a given process;
a first storing unit that stores to the data memory area set for each thread of the thread group, the value of the common variable for the thread of the execution order corresponding to the number specifying the output order of the data memory area; and
a second storing unit that upon completion of all threads of the thread group, reads out in the output order, each value of the common variable stored by the first storing unit to the data memory area for each thread, and that in the output order, overwrites a specific storage location with each read-out value of the common variable.

2. The information processing apparatus of claim 1, wherein
the memory unit is a graphic random access memory (GRAM) having a display device as the output destination.

3. A computer-readable recording medium storing an information processing program that causes a computer execute a process, wherein the computer accesses a memory unit having a number group specifying an output order to an output destination and a data memory area corresponding to each number or the number group and further accesses a control circuit that controls storage of data to the data memory area, the process comprising:
setting in each data memory area correlating an execution order of a thread with a number specifying the output order, a storage location for a value of a common variable of the thread among a group of threads receiving a write request for the value of the common variable in a given process;
storing to the data memory area set for each thread of the thread group, the value of the common variable for the thread of the execution order corresponding to the number specifying the output order of the data memory area; and
upon completion of all threads of the thread group, reading out in the output order, each value of the common variable stored by the first storing unit to the data memory area for each thread, and causing the control circuit to, in the output order, overwrite a specific storage location with each read-out value of the common variable.

4. An information processing method executes by a computer that accesses a memory unit having a number group specifying an output order to an output destination and a data memory area corresponding to each number of the number group and further accesses a control circuit that controls storage of data to the data memory area, the information processing method comprising:
setting in each data memory area correlating an execution order of a thread with a number specifying the output order, a storage location for a value of a common variable of the thread among a group of threads receiving a write request for the value of the common variable in a given process;
storing to the data memory area set for each thread of the thread group, the value of the common variable for the thread of the execution order corresponding to the number specifying the output order of the data memory area; and
upon completion of all threads of the thread group, reading out in the output order, each value of the common variable stored by the first storing unit to the data memory area for each thread, and causing the control circuit to, in the output order, overwrite a specific storage location with each read-out value of the common variable.
